(19) United States
(12) Patent Application Publication
(10) Pub. No.: US 2025/0370512 A1
(43) Pub. Date: Dec. 4, 2025

(54) MODULAR COMPUTING-DEVICE ACCESSORIES

(71) Applicant: MOBILE PIXELS INC., Irwindale, CA (US)

(72) Inventors: Xiaoliang Yao, Burlington, MA (US); Wenglong Ng, Burlington, MA (US)

(21) Appl. No.: 19/220,903

(22) Filed: May 28, 2025

Related U.S. Application Data
(60) Provisional application No. 63/652,947, filed on May 29, 2024.

(51) Int. Cl. G06F 1/16

(52) U.S. Cl. CPC G06F 1/1669

(57) ABSTRACT

Example of the disclosure include a modular computer peripheral including a display configured to be communicatively coupled to a computing device, the display including a first electrical connection and a second electrical connection, and a keyboard including a first keyboard section and a second keyboard section each configured to be communicatively coupled to the computing device, wherein the first keyboard section is configured to be electrically coupled to the first electrical connection to receive first charging power, and the second keyboard section is configured to be electrically coupled to the second electrical connection to receive second charging power.

### CROSS-REFERENCE TO RELATED APPLICATIONS

This application claims priority under 35 U.S.C. § 119(e) to U.S. Provisional Application Ser. No. 63/652,947, titled “MODULAR COMPUTING-DEVICE ACCESSORIES,” filed on May 29, 2024, which is hereby incorporated by reference in its entirety.

### BACKGROUND

### 1. Field of the Disclosure

At least one example in accordance with the present disclosure relates generally to computing devices.

### 2. Discussion of Related Art

Computing devices, such as laptop computers, desktop computers, tablet computers, and so forth, may be connected to accessory devices. Accessory devices may expand the functionality of the computing device by providing additional input or output interfaces for a user. For example, accessory devices may include computer mice, speakers, monitors, and so forth.

### SUMMARY

According to at least one aspect of the present disclosure, a modular computer peripheral is provided including a display configured to be communicatively coupled to a computing device, the display including a first electrical connection and a second electrical connection, and a keyboard including a first keyboard section and a second keyboard section each configured to be communicatively coupled to the computing device, wherein the first keyboard section is configured to be electrically coupled to the first electrical connection to receive first charging power, and the second keyboard section is configured to be electrically coupled to the second electrical connection to receive second charging power.

In at least one example, the first keyboard section is configured to be removably physically coupled to the second keyboard section. In at least one example, the first keyboard section is configured to be removably physically coupled to the second keyboard section via a magnetic connection. In at least one example, the first keyboard section is configured to be removably physically coupled to a first side of the display. In at least one example, the second keyboard section is configured to be removably physically coupled to a second side of the display. In at least one example, the first side is opposite the second side. In at least one example, the modular computer peripheral includes a first tilting component removably coupled to the first keyboard section and a second tilting component removably coupled to the second keyboard section.

In at least one example, the first tilting component is configured to be removably physically coupled to a bottom surface of the first keyboard section and the second tilting component is configured to be removably physically coupled to a bottom surface of the second keyboard section. In at least one example, the first tilting component is configured to be removably physically coupled to the bottom surface of the first keyboard section such that the first tilting component tilts the first keyboard section off of a surface on which the first keyboard section is placed, and wherein the second tilting component is configured to be removably physically coupled to the bottom surface of the second keyboard section such that the second tilting component tilts the second keyboard section off of the surface on which the second keyboard section is placed.

In at least one example, the first tilting component is configured to be removably physically coupled to a back section of the bottom surface of the first keyboard section, and wherein the second tilting component is configured to be removably physically coupled to a back section of the bottom surface of the second keyboard section. In at least one example, the first tilting component is configured to be removably physically coupled to a front section of the bottom surface of the first keyboard section, and wherein the second tilting component is configured to be removably physically coupled to a front section of the bottom surface of the second keyboard section. In at least one example, the first tilting component is configured to be removably physically coupled to an inner-edge section of the bottom surface of the first keyboard section, and wherein the second tilting component is configured to be removably physically coupled to an inner-edge section of the bottom surface of the second keyboard section.

In at least one example, the first tilting component is configured to be removably physically coupled to an outer-edge section of the bottom surface of the first keyboard section, and wherein the second tilting component is configured to be removably physically coupled to an outer-edge section of the bottom surface of the second keyboard section. In at least one example, the display is configured to receive input charging power from the computing device and to provide, to the first keyboard section via the first electrical connection, the first charging power derived from the input charging power, and provide, to the second keyboard section via the second electrical connection, the second charging power derived from the input charging power.

In at least one example, the display includes a display screen and a base section. In at least one example, the base section includes one or more sliding tracks. In at least one example, the display includes at least one sliding coupler configured to be slidably coupled to the one or more sliding tracks. In at least one example, the display includes an orientation arm rotatably coupled to the display screen at a first end and to the base section at a second end. In at least one example, sliding the display screen along the one or more sliding tracks rotates the display screen about the orientation arm. In at least one example, the display includes a first magnetic connection to physically connect a first side of the display to the first keyboard section, and includes a second magnetic connection to physically connect a second side of the display to the second keyboard section, wherein the first side of the display is opposite the second side of the display.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a modular accessory system according to an example;

FIG. 2 illustrates a top-down view of one example of a modular accessory in a connected configuration according to an example;

FIG. 3 illustrates a top-down view of one example of the modular accessory in a disconnected configuration according to an example;

FIG. 4 illustrates a top-down view of one example of the modular accessory in a connected configuration according to another example;

FIG. 5A illustrates a left-side view of the modular accessory according to an example;

FIG. 5B illustrates a right-side view of the modular accessory according to an example;

FIG. 5C illustrates a front view of the modular accessory according to an example;

FIG. 5D illustrates a back view of the modular accessory according to an example;

FIG. 5E illustrates a top-down view of the modular accessory according to an example;

FIG. 5F illustrates a back-perspective, partially cut-away view of a portion of the modular accessory according to an example;

FIG. 5G illustrates a front-perspective, partially cut-away view of a portion of the modular accessory according to an example;

FIG. 6A illustrates a perspective view of the modular accessory system according to an example;

FIG. 6B illustrates a top-down view of the modular accessory system according to an example;

FIG. 7A illustrates a top-down view of the modular accessory according to an example;

FIG. 7B illustrates a bottom-up view of the modular accessory in a first tilted position according to an example;

FIG. 7C illustrates a right-side view of the modular accessory in the first tilted position according to an example;

FIG. 7D illustrates a bottom-up view of the modular accessory in a second tilted position according to an example;

FIG. 7E illustrates a right-side view of the modular accessory in the second tilted position according to an example;

FIG. 7F illustrates a bottom-up view of the modular accessory in a third tilted position according to an example; and

FIG. 7G illustrates a front view of the modular accessory in the third tilted position according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As discussed above, computing devices may be connected to accessory devices. Accessory devices include devices that expand the functionality of the computer to which the devices are connected. Some accessory devices, such as keyboards, have evolved to be more ergonomic over time. Non-ergonomic keyboards may encourage a user to orient their body in a position that adversely affects posture and joint health. An ergonomic keyboard can assist users in positioning their body in a comfortable and healthy position, with the user's shoulders relaxed, the arms close to the torso, and the hands at a relaxed angle.

For example, an ergonomic keyboard may include a single device with two sections of keys, the sections being separated roughly by a dividing line in the middle of the single device. Each section of keys may be angled outward from the dividing line such that a user's hands are oriented inward towards the torso rather than straight ahead. Angling the user's body and hands in such an orientation may support healthy posture in the user.

However, some ergonomic keyboards may be fixed and non-customizable. For example, the two sections of the keyboard may be oriented at a fixed angle, and the keyboard may have a fixed width. Accordingly, such fixed keyboards may be well-suited for some users but less helpful for other users.

Examples of the disclosure include a modular accessory. The modular accessory may operate at least in part as a keyboard, and may thus be referred to as a modular keyboard in some examples. The modular keyboard may be modular inasmuch as the keyboard includes multiple detachable, modular sections which may form a first part and a second part of a keyboard. For example, some example modular keyboards may include modular sections which form a first half and a second half of a keyboard. The user may use one hand to operate one half, and the other hand to operate the other half. The user may orient each half at a desired position and orientation which is most ergonomic for each hand. In various examples, the modular accessory may further include additional modular components, such as a display, a control panel, and/or other components.

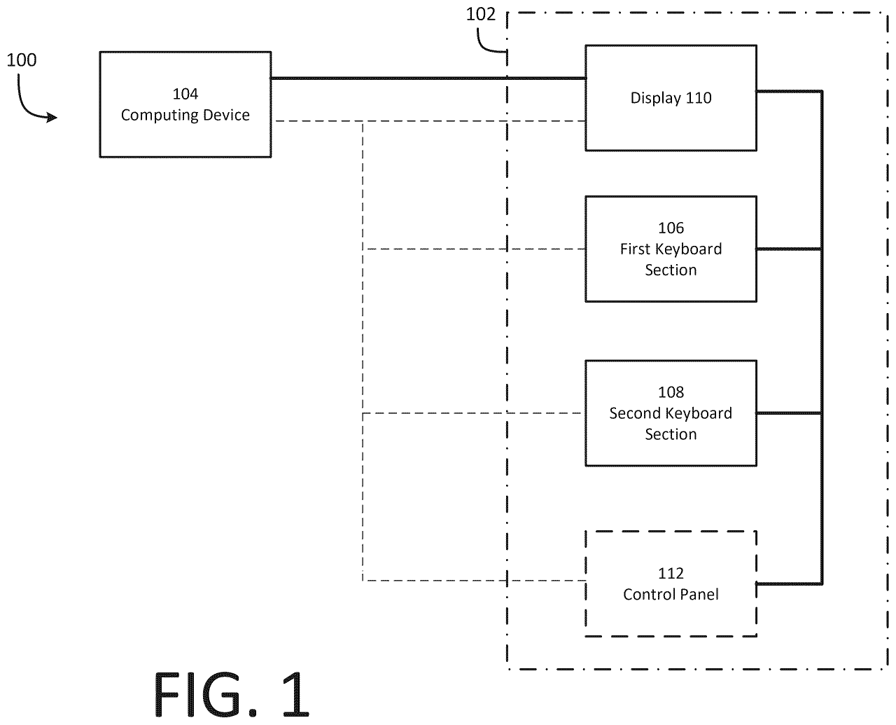

FIG. 1 illustrates a block diagram of a modular accessory system 100 according to an example. The modular accessory system 100 includes a modular accessory 102 and a computing device 104. The modular accessory 102, or modular computer peripheral 102, may be communicatively and/or electrically coupled to the computing device 104, which may be a laptop computer, desktop computer, tablet computer, or other type of computer.

The modular accessory 102 may include two discrete keyboard sections including a first keyboard section 106 and a second keyboard section 108, which may be collectively referred to as, and/or function as, a keyboard. The modular accessory 102 may further include a display 110. In some examples, the modular accessory 102 may further include an optional control panel 112. In other examples, the modular accessory 102 may be omitted.

A user may position and orient each of the keyboard sections 106, 108 in a desired configuration. The keyboard sections 106, 108 may not be fixedly physically coupled to one another, and thus the keyboard sections 106, 108 may be positioned and oriented independent of one another. Although in some examples the keyboard sections 106, 108 may optionally be removably physically coupled to one another, such as via a magnetic connection, a user may be capable of easily decoupling the keyboard sections 106, 108 from one another. For example, if the keyboard sections 106, 108 are magnetically coupled to one another, a user may separate the two keyboard sections 106, 108 by pulling the keyboard sections 106, 108 apart.

The user may choose to operate the first keyboard section 106 with one hand, and may operate the second keyboard section 108 with the other hand. Because the two sections 106, 108 may not be fixedly physically coupled to each other, the user is free to orient each section in a desired position for each hand. In various examples, each keyboard section may be wirelessly connected to the computing device 104 such that the orientability of the sections 106, 108 is not impacted by a wired connection.

The modular accessory 102 may further include the display 110. The display 110 may output information received from the computing device 104. In some examples, the display 110 may be a touch-screen display and may be configured to receive input information from a user. For example, the display 110 may display shortcuts for applications executed by the computing device 104, such as a word-processing application, a video-playing application, a music-playing application, and so forth. If the display 110 is a touch screen, a user may click on a visual icon for any of the applications to instruct the computing device 104 to activate or switch to those applications. In other examples, the display 110 may display any other type of information for the computing device 104. As discussed in greater detail below, the display 110 may include at least one display screen which is capable of being tilted and/or tented to a desired orientation.

In some examples, the display 110 may be wirelessly communicatively coupled to the computing device 104. The display 110 may further be electrically coupled to the computing device 104 via a wired connection to receive power. In some examples, the display 110 is configured to be selectively electrically coupled to the keyboard sections 106, 108 and to the control panel 112 to provide charging power received from the computing device 104 to the keyboard sections 106, 108 and the control panel 112. Because the display routes charging power from the computing device 104 to the keyboard sections 106, 108 and the control panel 112 in these examples, the display 110 may be referred to as a “passthrough charger,” and such charging may be referred to as “passthrough charging.”

The modular accessory 102 may further include the control panel 112. The control panel 112 may include several user-interface components. For example, the control panel 112 may include buttons, knobs, dials, a combination thereof, and so forth. The control panel 112 may also include a small display screen to display small amounts of information, such as stock-ticker information.

The control panel 112 may be communicatively coupled to the computing device 104, and may be configured to receive information from, and provide information to, the computing device 104. In some examples, the control panel 112 includes an array of buttons, or “hot keys,” which may have functions configured by a user. For example, a user may configure a first button to increase or decrease the volume of audio output by the computing device 104, a second button to open a certain application, a third button to power down the computing device 104, and so forth.

In various examples, each component 106-112 of the modular accessory 102 may be removably coupled to the other components of the modular accessory 102. For example, each component 106-112 may include physical connections to couple to corresponding connections of the other components 106-112. In one configuration, the keyboard sections 106, 108 may be coupled to either side of the display 110 such that the display 110 is sandwiched between the keyboard sections 106, 108. The control panel 112 may be coupled to the other side of either of the keyboard sections 106, 108. In various examples, the physical connections include magnetic connections.

One or more of the components 106-112 may also be electrically coupled to the other components 106-112. For example, as discussed above, the display 110 may provide passthrough charging to the keyboard sections 106, 108, and may additionally provide passthrough power to the control panel 112. The electrical coupling may be integrated with the physical coupling such that establishing a physical connection further includes establishing an electrical connection. For example, such electrical connections may include inductive-charging connections and/or physical electrical connections that align and form an electrical connection when the display 110 is physically coupled to the keyboard sections 106, 108 and/or control panel 112.

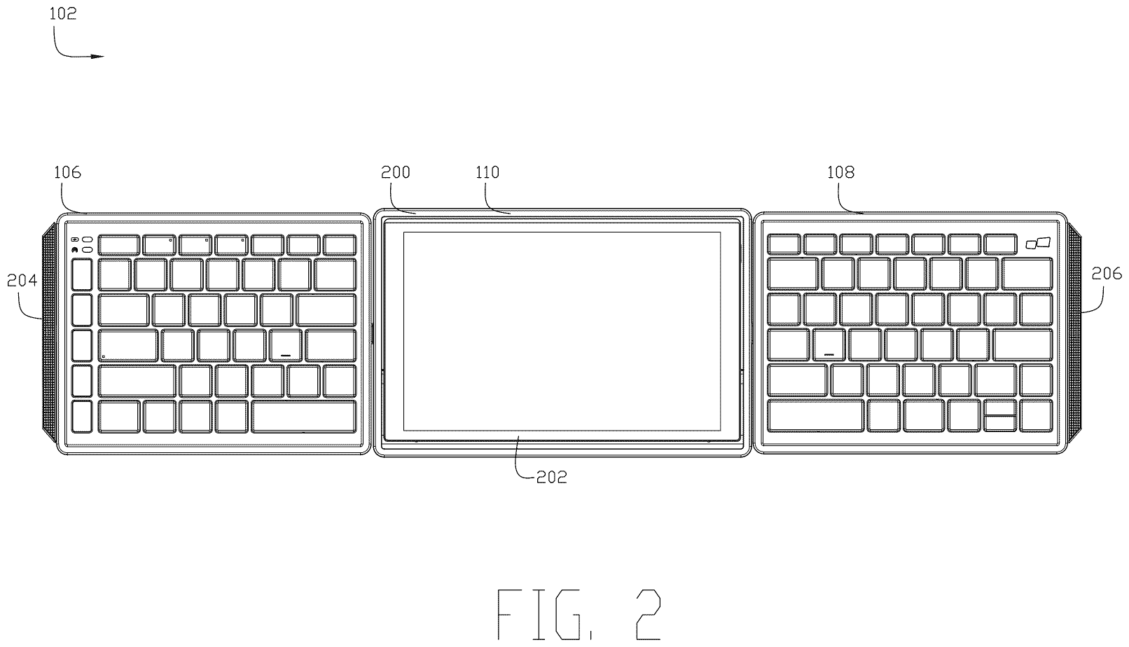

FIG. 2 illustrates a top-down view of one example of the modular accessory 102 in a connected configuration according to an example. In the example of FIG. 2, the modular accessory 102 includes an example of the keyboard sections 106, 108 and an example of the display 110. Although not explicitly illustrated, each of the keyboard sections 106, 108 and the display 110 may be communicatively coupled to a computing device, such as the computing device 104.

The display 110 includes a base section 200 and a display screen 202. The base section 200 may be placed on a surface that a user is working at, such as a desk. The display screen 202 may display output information to a user. For example, the display screen 202 may display output information based on information received from the computing device 104. As discussed in greater detail below, a user may be able to re-orient the display screen 202 relative to the base section 200. For example, the display screen 202 may slide and/or rotate relative to the base section 200 such that a user can orient the display screen 202 in a desired orientation.

The first keyboard section 106 includes a first tilting component 204 and the second keyboard section 108 includes a second tilting component 206. The tilting components 204, 206 may be removably coupled to the keyboard sections 106, 108, respectively. For example, the tilting components 204, 206 may be magnetically coupled to, and/or decoupled from, the keyboard sections 106, 108. As discussed in greater detail below, a user may decouple the tilting components 204, 206 from the sides of the keyboard sections 106, 108 and couple the tilting components 204, 206 to a bottom surface of the keyboard sections 106, 108.

Coupling the tilting components 204, 206 to the bottom surface of the keyboard sections 106, 108 may tilt the keyboard sections 106, 108 in a manner that depends on where on the keyboard sections 106, 108 the tilting components 204, 206 are positioned. Thus, a user may couple the tilting components 204, 206 to the bottom of the keyboard sections 106, 108 when the user wishes to use the keyboard sections 106, 108 at an angle relative to a surface on which the keyboard sections 106, 108 are placed (for example, a desk surface that the user is working at), and may couple the tilting components 204, 206 to the sides of the keyboard sections 106, 108 when the user wishes to use the keyboard section 106, 108 in a flat orientation relative to the surface on which the keyboard sections 106, 108 are placed.

In the connected configuration, the keyboard sections 106, 108 are each coupled (for example, physically and electrically) to the display 110. For example, the keyboard sections 106, 108 and/or the display 110 may be wireless communicatively coupled to the computing device 104. The display 110 may further be electrically coupled to the computing device 104 via a wired connection. The display 110 may receive charging power from the computing device 104 via the wired connection. When the display 110 is physically coupled to the keyboard sections 106, 108 as illustrated in the connected configuration of FIG. 2, the display 110 may also provide passthrough charging to the keyboard sections 106, 108 via an electrical connection.

Accordingly, of the input power that the display 110 receives from the computing device 104, a first portion of the input power may be provided to the first keyboard section 106 as first charging power and a second portion of the input power may be provided to the second keyboard section 108 as second charging power. The first keyboard section 106 may include a first energy-storage device, such as a battery, to store energy derived from the first charging power, and the second keyboard section 108 may include a second energy-storage device, such as a battery, to store energy derived from the second charging power. Furthermore, the display 110 may use some of the input power to power the display 110 itself.

A user may pull either of the keyboard sections 106, 108 away from the display 110 to physically separate the keyboard sections 106, 108 from the display 110 and thereby discontinue any passthrough charging to the keyboard sections 106, 108. However, the keyboard sections 106, 108 may remain communicatively coupled to the computing device 104 to continue exchanging information with the computing device 104 (for example, at least by sending user-input information indicative of keystrokes to the computing device 104).

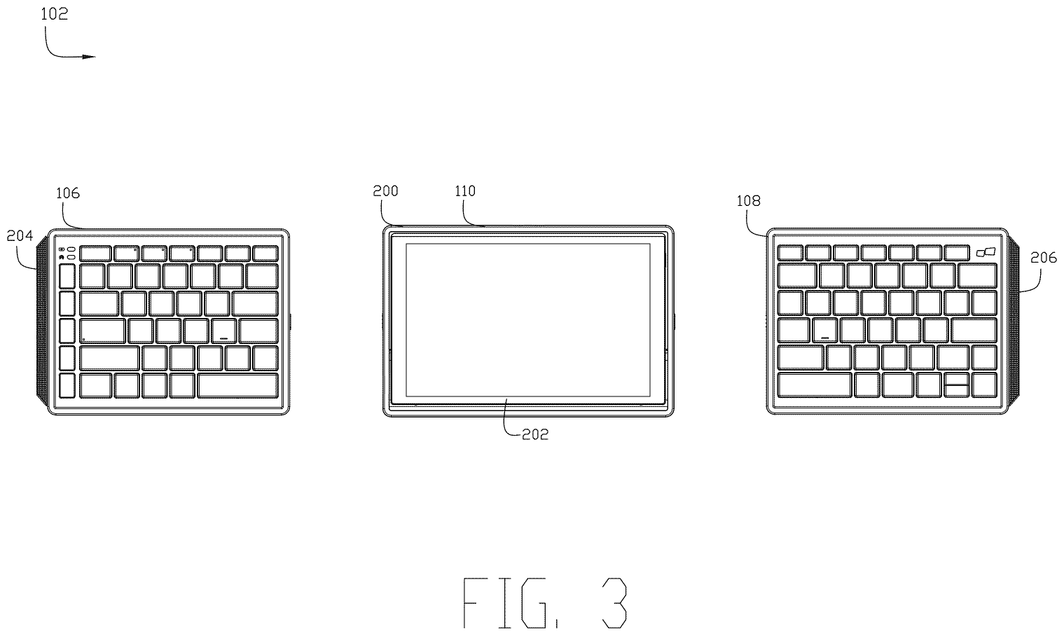

For example, FIG. 3 illustrates a top-down view of one example of the modular accessory 102 in a disconnected configuration according to an example. As illustrated in FIG. 3, the keyboard sections 106, 108 are physically and electrically decoupled from the display 110. However, the keyboard sections 106, 108 may remain communicatively coupled to the computing device 104. The display 110 may also remain electrically and communicatively coupled to the computing device 104 via, for example, a wired connection.

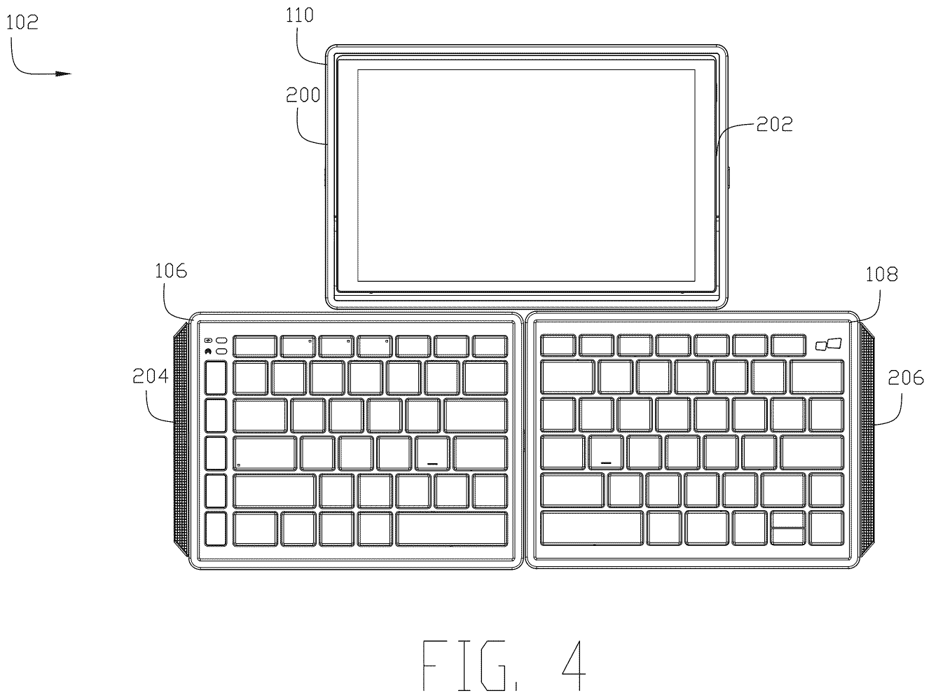

Accordingly, a user may couple and/or decouple the keyboard sections 106, 108 to and from the display 110. Furthermore, a user may couple and/or decouple the keyboard sections 106, 108 to each other. FIG. 4 illustrates a top-down view of one example of the modular accessory 102 in a connected configuration according to another example. As illustrated in FIG. 4, the keyboard sections 106, 108 are physically coupled to one another, but physically and electrically decoupled from the display 110. A user may couple the keyboard sections 106, 108 together as shown in FIG. 4 if, for example, the user prefers to use the keyboard sections 106, 108 as a single unit, similar to a singular monolithic keyboard. The user may still position and/or orient the display 110 in a manner that the user desires.

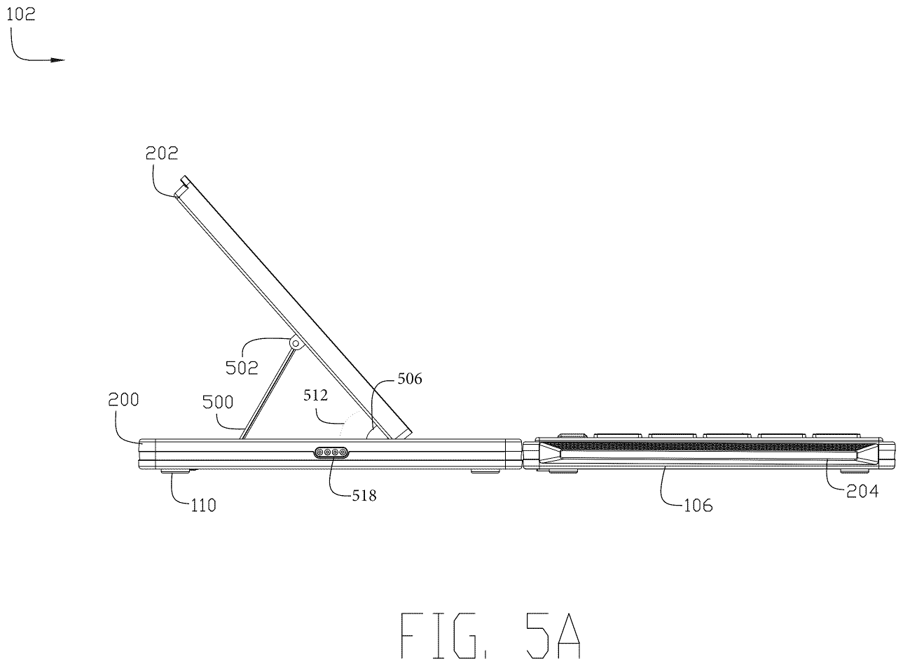

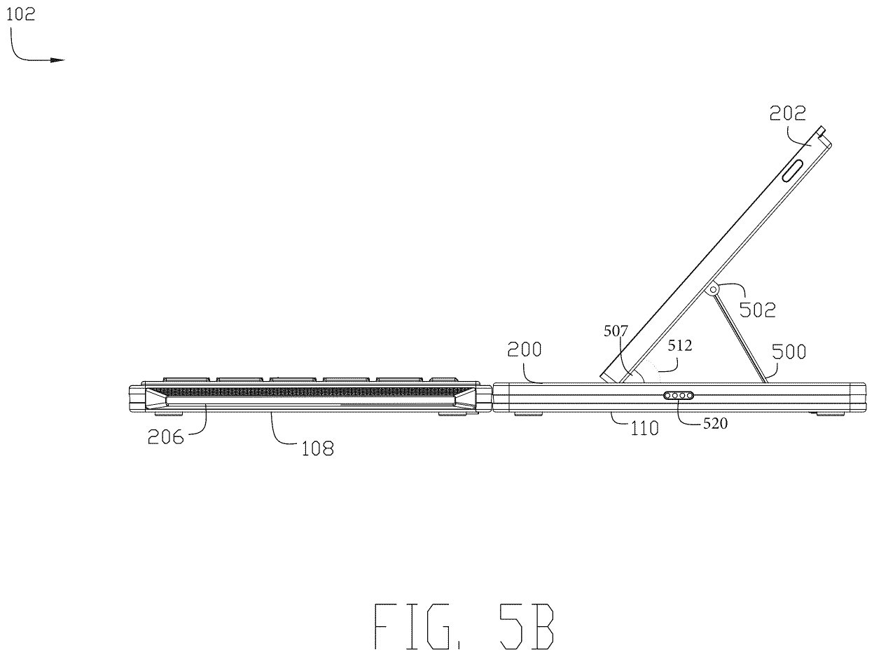

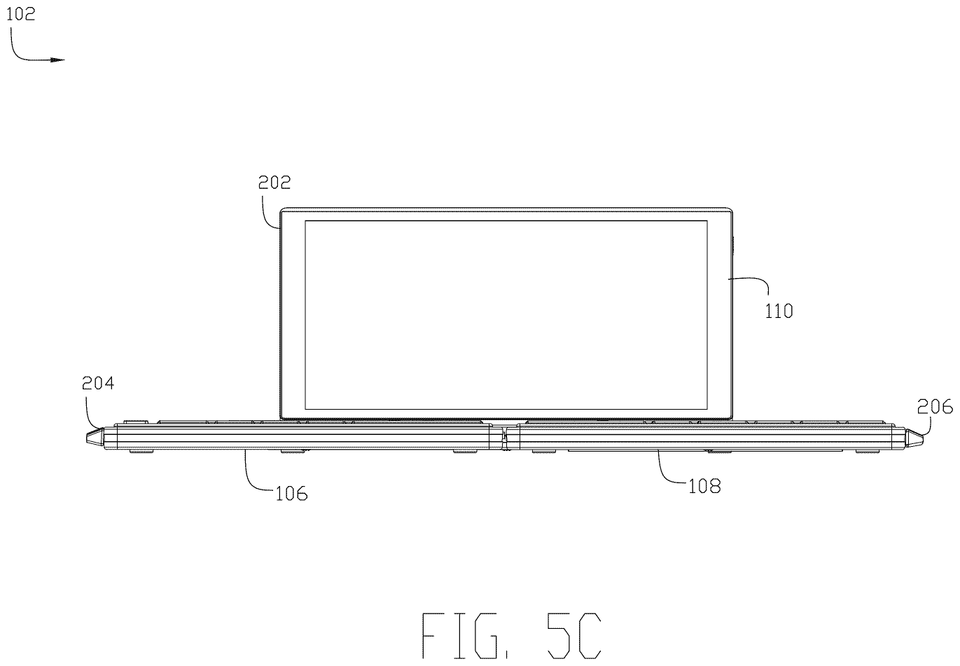

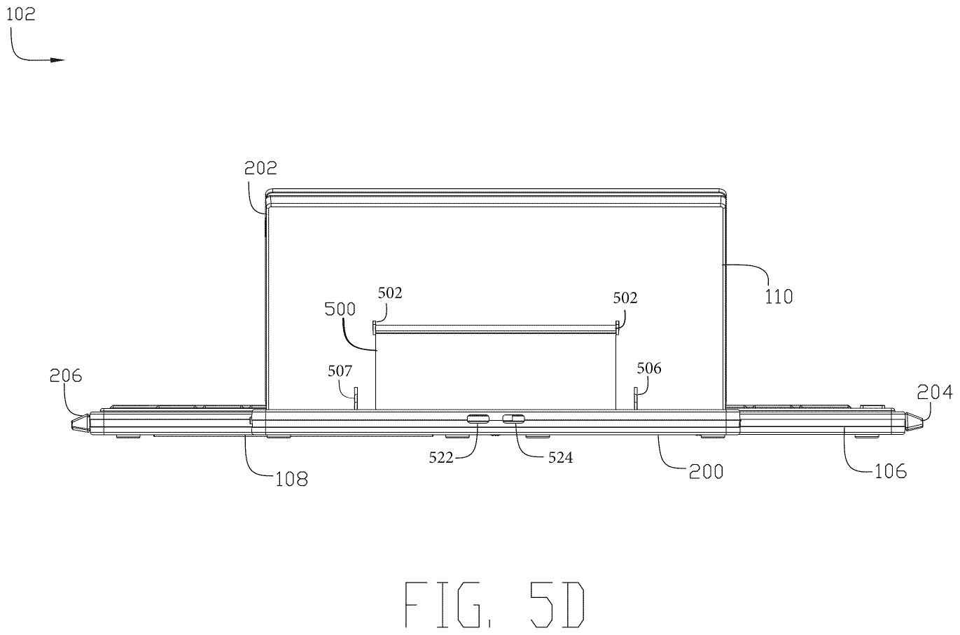

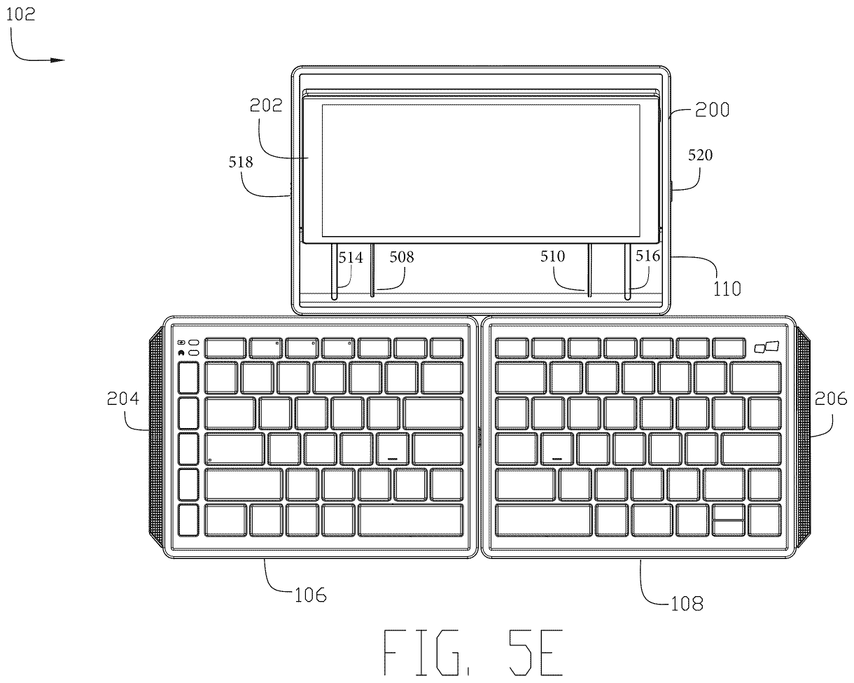

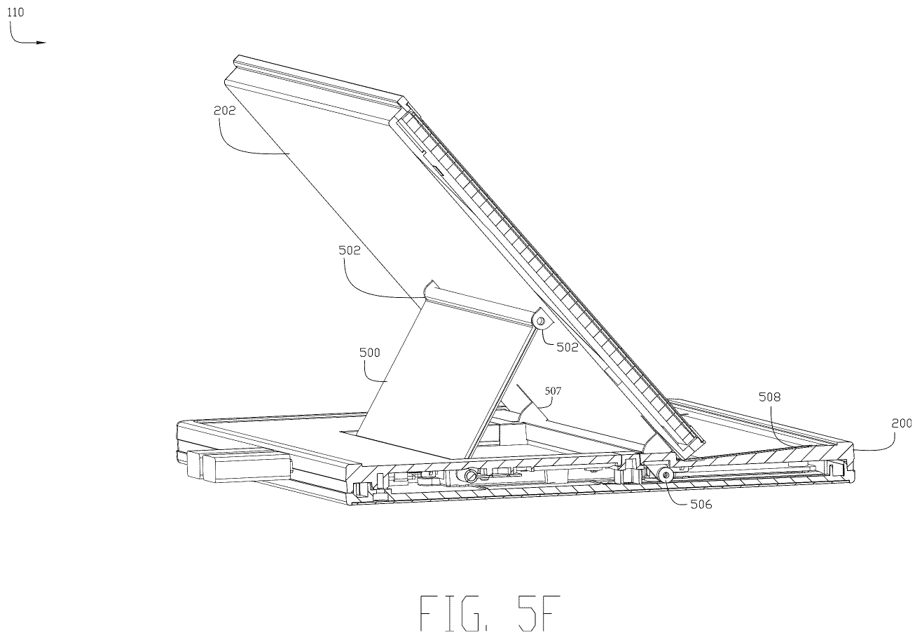

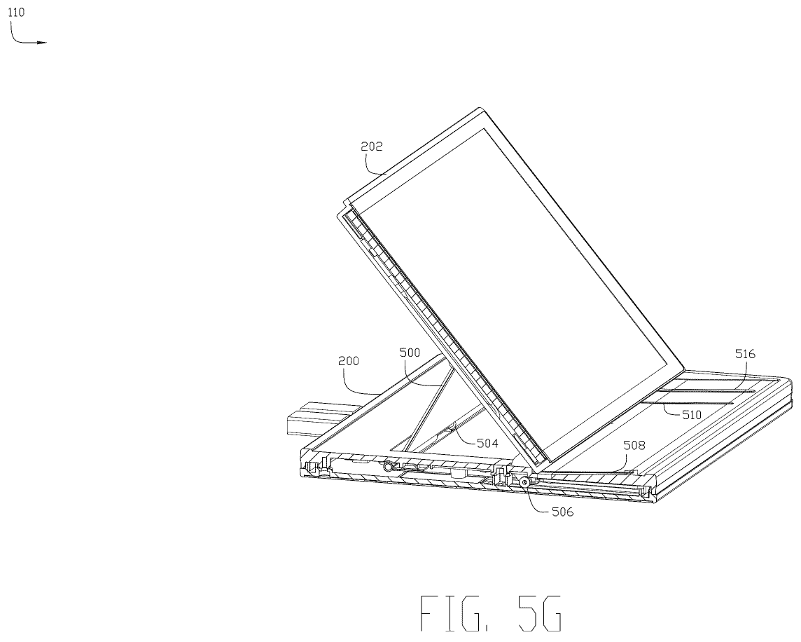

For example, the user may tilt the display 110 to a desired orientation, as illustrated in FIGS. 5A-5G. FIG. 5A illustrates a left-side view of the modular accessory 102 according to an example. FIG. 5B illustrates a right-side view of the modular accessory 102 according to an example. FIG. 5C illustrates a front view of the modular accessory 102 according to an example. FIG. 5D illustrates a back view of the modular accessory 102 according to an example. FIG. 5E illustrates a top-down view of the modular accessory 102 according to an example. FIG. 5F illustrates a back-perspective, partially-cutaway view of a portion of the modular accessory 102 (including, for example, the display 110) according to an example. FIG. 5G illustrates a front-perspective, partially cut-away view of a portion of the modular accessory 102 (including, for example, the display 110) according to an example.

As illustrated at least in FIGS. 5A, 5B, 5D, 5F, and 5G, the display 110 includes an orientation arm 500. The orientation arm 500 is coupled to the display screen 202 at a first end and is rotatably coupled to the base section 200 at a second end. In some examples, the orientation arm 500 is rotatably coupled to the display screen 202 at a hinged connection 502 (as illustrated at least in FIGS. 5A, 5B, 5D, and 5F) at the first end, and is rotatably coupled to the base section 200 at a second hinged connection 504 (as illustrated at least in FIG. 5G) at the second end. As illustrated in FIG. 5F, the hinged connection 502 may include multiple hinges rotatably coupling the orientation arm 500 to the display screen 202.

The display screen 202 is further coupled to the base section 200 by at least one sliding coupler. In various examples, the at least one sliding coupler incudes two sliding couplers. FIGS. 5A, 5F, and 5G illustrate a first sliding coupler 506. FIG. 5B illustrates a second sliding coupler 507. Each of the sliding couplers 506, 507 is slidably coupled to the base section 200 and includes at least one hinge such that the sliding couplers 506, 507 slidably and rotatably couple the display screen 202 to the base section 200. The first sliding coupler 506 may be implemented on a left-hand side of the display 110, and the second sliding coupler 507 may be implemented on a right-hand side of the display 110 in a position symmetrical to the first sliding coupler 506.

As illustrated at least in FIGS. 5E-G, the base section 200 further includes a first track 508 and a second track 510. The display screen 202 is configured to slide along the tracks 508, 510. For example, the first sliding coupler 506 may be slidably coupled to the first track 508, and the second sliding coupler 507 may be slidably coupled to the second track 510.

A user may orient the display screen 202 to a desired orientation by sliding the display screen 202 forwards and backwards along the tracks 508, 510. As the user pushes the display screen 202 forwards and backwards, the display screen 202 slides along the tracks 508, 510 via the sliding couplers 506, 507. As the display screen 202 slides forwards and backwards, the display screen 202 rotates about the connection arm 500 via the hinged connection 502 and rotates about (and slides along) the base section 200 via the sliding couplers 506, 507. The connection arm 500, in turn, rotates about the base section 200 via the second hinged connection 504. In other examples, the display screen 202 may include additional or fewer sliding couplers in the same or different positions, and the base section 200 may include a corresponding number and position of tracks.

Rotating the display screen 202 about the base section 200 adjusts an orientation angle 512 between the display screen 202 and the base section 200. A user may therefore slide the display screen 202 forwards and backwards to adjust the orientation angle 512 until the display screen 202 is angled at a desired orientation (for example, an orientation at which the user may easily view the display screen 202).

In at least one example, the hinged connection 502 and/or the sliding couplers 506, 507 may each include at least one torque hinge. The torque hinge(s) may resist rotation below a threshold moment being applied to the torque hinge(s). In various examples, unless a user pushing or pulling the display screen 202 to reposition the display screen 202, the hinged connection 502 and/or the sliding couplers 506, 507 resist rotation (for example, in response to the force of gravity) such that the display screen 202 maintains its orientation.

Furthermore, in various examples the base section 200 includes a first friction strip 514 and a second friction strip 516. Each of the friction strips 514, 516 may include a strip of material on the base section 200 that the display screen 202 contacts. The friction strips 514, 516 may include a material with a relatively high coefficient of static and/or kinetic friction (for example, rubber) such that the display screen 202 does not easily slide along the friction strips 514, 516. The physical contact between the display screen 202 and the friction strips 514, 516 may aid in maintaining the display screen 202 at a desired position, and thus maintain a desired orientation angle 512. The friction strips 514, 516 may work in combination with, or in lieu of, the torque hinges discussed above to prevent the display screen 202 from sliding along the base section 200 solely under the force of gravity. In other examples, the base section 200 may include additional or fewer friction strips with the same or different positions and/or shapes.

As illustrated at least in FIGS. 5A and 5B, the display 110 includes a left-side electrical connection 518 and a right-side electrical connection 520. The left-side electrical connection 518 is configured to be electrically coupled to, and deliver charging power to, the first keyboard section 106 when the first keyboard section 106 is coupled to the left-hand side of the display 110. For example, the left-side electrical connection 518 may include electrical contacts, and the first keyboard section 106 may include one or more spring-loaded pins (or “pogo pins”) configured to establish an electrical connection with each other. In another example, the left-side electrical connection 518 may include one or more spring-loaded pins and the first keyboard section 106 may include corresponding electrical contacts.

The right-side electrical connection 520 is configured to be electrically coupled to, and deliver charging power to, the second keyboard section 108 when the second keyboard section 108 is coupled to the right-hand side of the display 110. For example, the right-side electrical connection 520 may include electrical contacts, and the second keyboard section 108 may include one or more spring-loaded pins (or “pogo pins”) configured to establish an electrical connection with each other. In another example, the right-side electrical connection 520 may include one or more spring-loaded pins and the second keyboard section 108 may include corresponding electrical connections. The display 110 therefore delivers passthrough-charging power to the keyboard sections 106, 108 via the electrical connections 518, 520, respectively.

As illustrated in FIG. 5D, a back of the display 110 includes a first wired connection 522 and a second wired connection 524. Each of the wired connections 522, 524 may be configured to be coupled to a wired connector. For example, each of the wired connections 522, 524 may be coupled to a respective wired connector to establish a wired connection with a respective computing device.

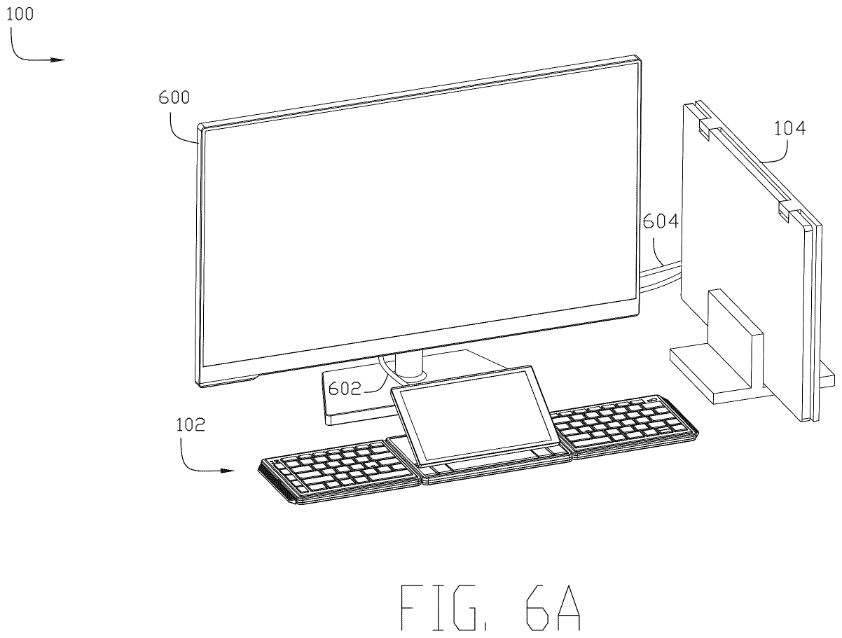

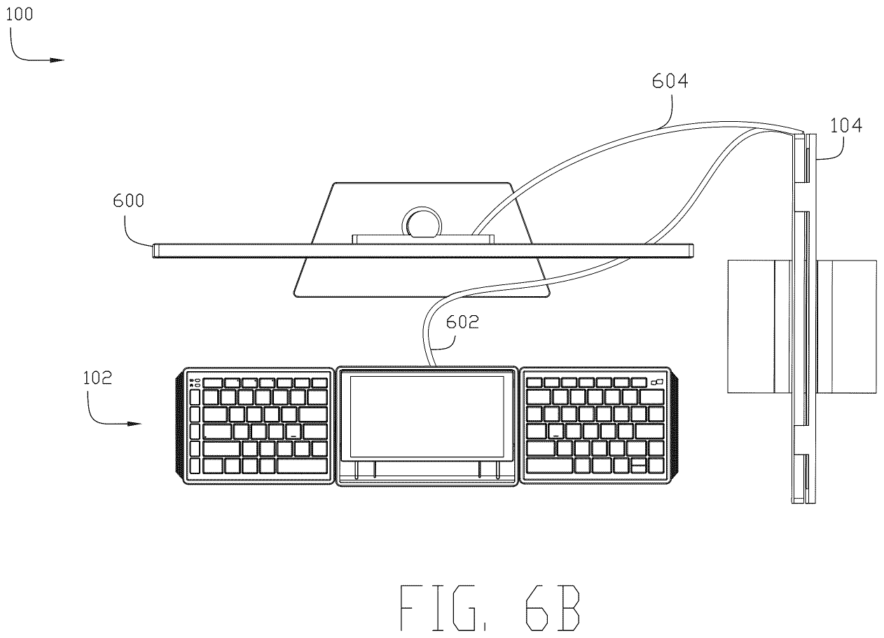

FIG. 6A illustrates a perspective view of the modular accessory system 100 according to an example. FIG. 6B illustrates a top-down view of the modular accessory system 100 according to an example. The example modular accessory system 100 of FIGS. 6A and 6B includes an example of the modular accessory 102 and an example of the computing device 104. The modular accessory system 100 further includes an additional monitor 600.

The modular accessory 102 is coupled to the computing device 104 via a first wired connector 602. The computing device 104 may provide power to, and exchange information with, the modular accessory 102 via the first wired connector 602. For example, the computing device 104 may receive user-input information indicative of one or more user keystrokes from the user. The first wired connector 602 may be coupled to one of the wired connections 522, 524.

The additional monitor 600 is coupled to the computing device 104 via a second wired connector 604. The computing device 104 may provide power to, and exchange information with, the additional monitor 600 via the second wired connector 604. For example, the computing device 104 may send output display information to the additional monitor 600.

In various examples, therefore, a user may use the display screen 202 and the additional monitor 600 as computer monitors. In other examples, the additional monitor 600 (and the second wired connector 604) may be omitted such that the user uses only the display screen 202 as a monitor.

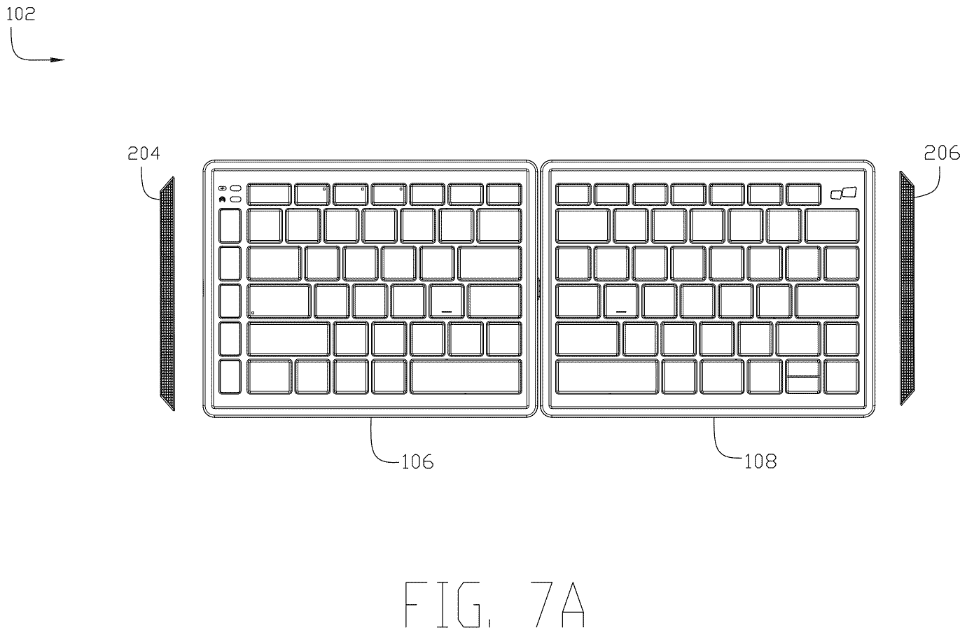

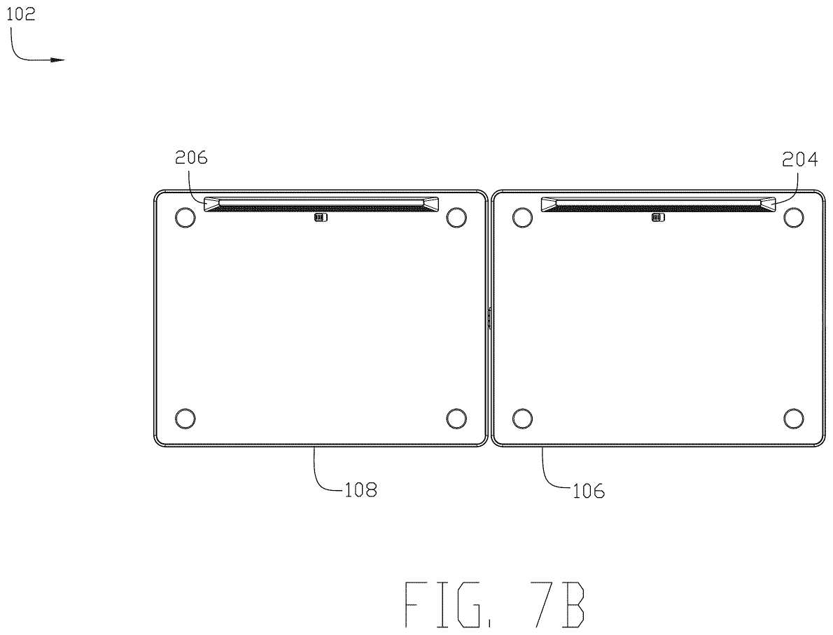

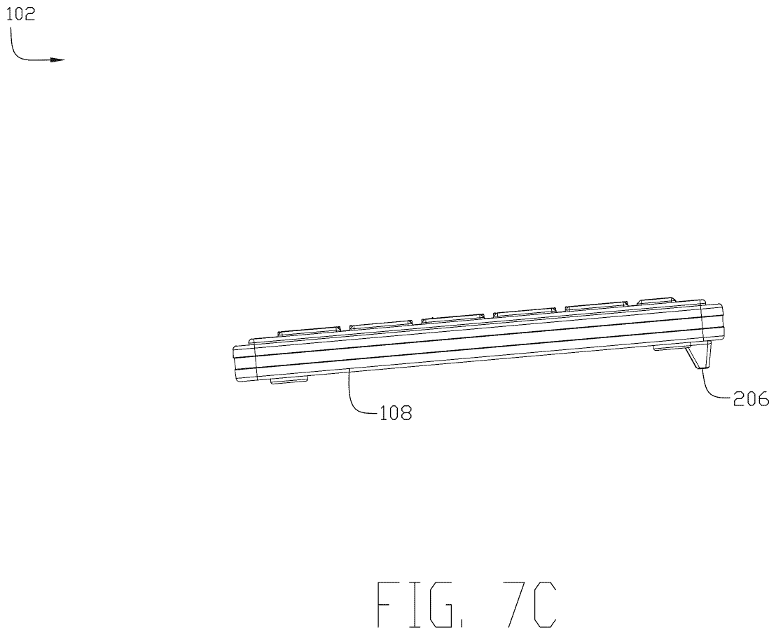

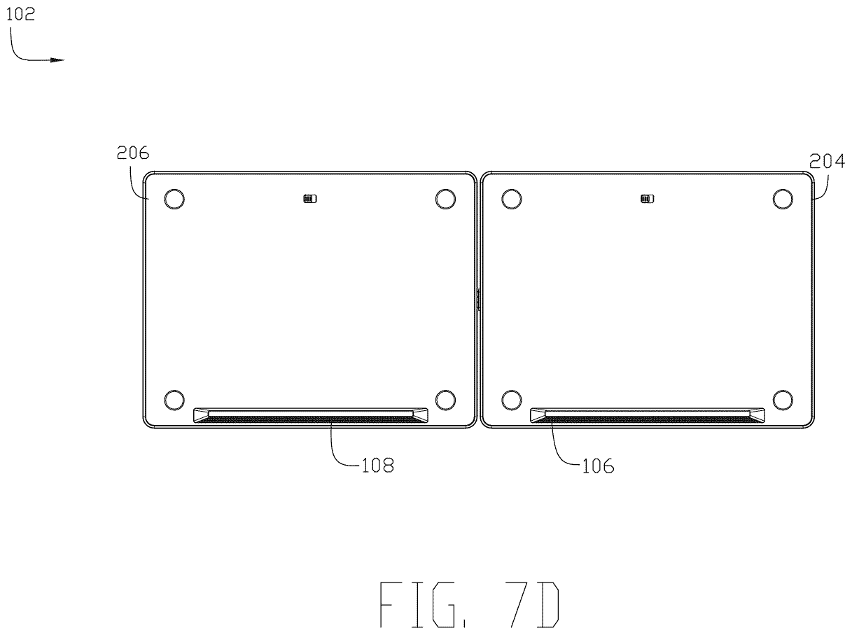

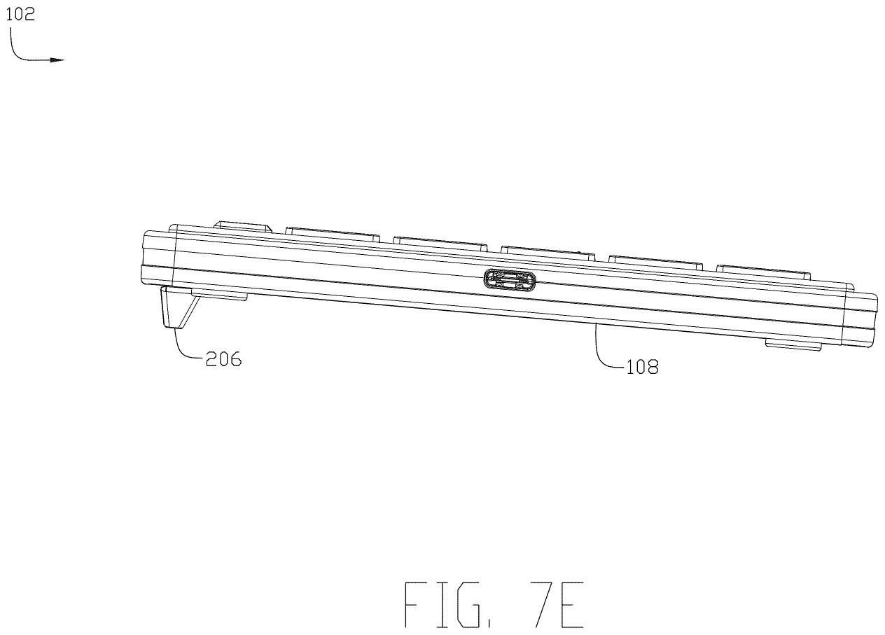

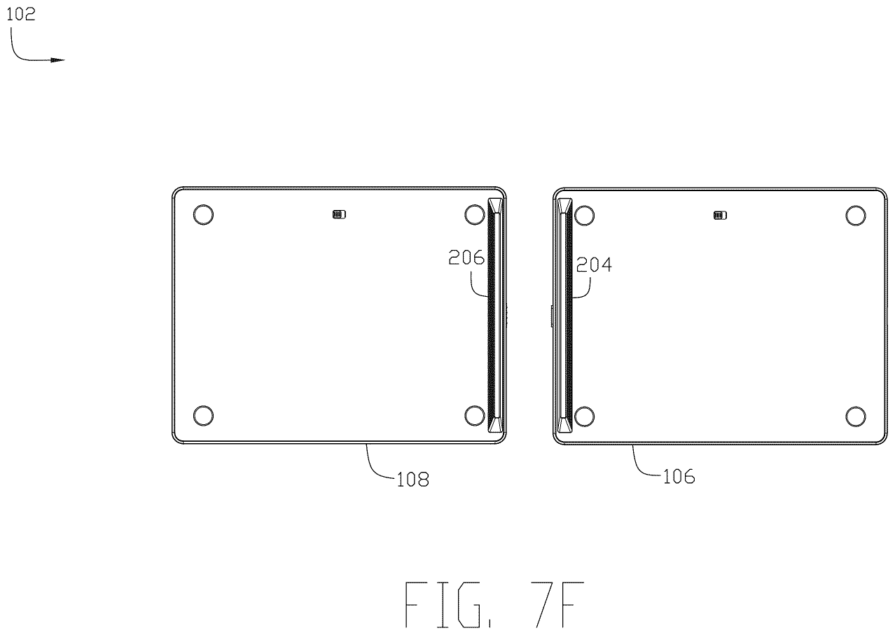

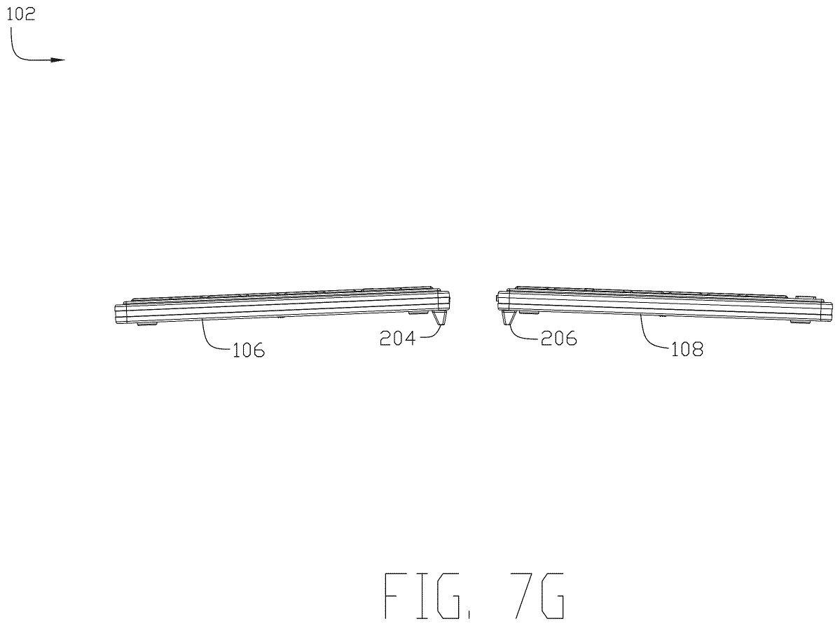

As discussed above, the tilting components 204, 206 may be decoupled from the sides of the keyboard sections 106, 108 and attached to the bottom of the keyboard sections 106, 108 to tilt the keyboard sections 106, 108. For example, FIG. 7A illustrates a top-down view of the modular accessory 102 according to an example. As illustrated in FIG. 7A, a user may detach the tilting components 204, 206 from the sides of the keyboard sections 106, 108. The user may then attach the tilting components 204, 206 to the bottom of the keyboard section 106, 108 at a desired location. In some examples, the tilting components 204, 206 and the keyboard sections 106, 108 may each include magnets to establish a magnetic connection between the tilting components 204, 206 and the keyboard sections 106, 108 at various positions on the keyboard sections 106, 108.

For example, FIG. 7B illustrates a bottom-up view of the modular accessory 102 in a first tilted position according to an example. As illustrated in FIG. 7B, the user may attach the tilting components 204, 206 to the bottom of the keyboard sections 106, 108 near the back of the keyboard sections 106, 108 (that is, the portion of the keyboard sections 106, 108 which is farthest from the user during use). The keyboard sections 106, 108 may include magnets near the back of the keyboard sections 106, 108 to establish a magnetic connection at a desired location.

FIG. 7C illustrates a right-side view of the modular accessory 102 in the first tilted position according to an example. As illustrated in FIG. 7C, the keyboard sections 106, 108 are tilted forwards towards a user because the tilting components 204, 206 elevate the back of the keyboard sections 106, 108.

FIG. 7D illustrates a bottom-up view of the modular accessory 102 in a second tilted position according to an example. As illustrated in FIG. 7D, the user may attach the tilting components 204, 206 to the bottom of the keyboard sections 106, 108 near the front of the keyboard sections 106, 108 (that is, the portion of the keyboard sections 106, 108 which is closest to a user during use). The keyboard sections 106, 108 may include magnets near the front of the keyboard sections 106, 108 to establish a magnetic connection at a desired location.

FIG. 7E illustrates a right-side view of the modular accessory 102 in the second tilted position according to an example. As illustrated in FIG. 7C, the keyboard sections 106, 108 are tilted backwards away from a user because the tilting components 204, 206 elevate the front of the keyboard sections 106, 108.

FIG. 7F illustrates a bottom-up view of the modular accessory 102 in a third tilted position according to an example. As illustrated in FIG. 7F, the user may attach the tilting components 204, 206 to the bottom surface of the keyboard sections 106, 108 in an inner-edge section near the inner edges of the keyboard sections 106, 108 (that is, the portion of the keyboard sections 106, 108 where the keyboard sections may be physically coupled to one another). The keyboard sections 106, 108 may include magnets near the inner edges of the keyboard sections 106, 108 to establish a magnetic connection at a desired location.

FIG. 7G illustrates a front view of the modular accessory 102 in the third tilted position according to an example. As illustrated in FIG. 7G, the keyboard sections 106, 108 are tilted outwards in a tented configuration. By tilting the keyboard sections 106, 108 outwards, a user may operate the keyboard sections 106, 108 with a more neutral hand position, which many users may find more ergonomic. In some examples, the tilting components 204, 206 may be coupled near the outer edges of the keyboard sections 106, 108 (that is, the portion of the keyboard sections 106, 108 opposite where the keyboard sections may be physically coupled to one another) to tilt the keyboard sections 106, 108 inwards. For example, from the perspective of FIG. 7F, the first tilting component 204 may be coupled to the first keyboard section 106 in an outer-edge section of the first keyboard section 106 which is near the righthand side of the first keyboard section 106, and the second tilting component 206 may be coupled to the second keyboard section 108 in an outer-edge section of the second keyboard section 108 which is near the lefthand side of the second keyboard section 108. However, some users may find the third configuration illustrated in FIGS. 7F and 7G to be more ergonomic and thus preferable.

As discussed above, the tilting components 204-206 may be coupled to the bottom of the keyboard sections 106, 108 at various positions to support various different tilted orientations of the keyboard sections 106, 108. In some examples, the tilting components 204-206 or similar tilting components may be coupled to the bottom of the display screen 110 to orient the display screen 110 to a desired orientation. For example, some users may couple one or more tilting components to the back of the bottom of the display screen 110 such that the display screen 110 is tilted forwards towards the user.

As discussed above, in some examples, the modular accessory system 100 may include the control panel 112. The control panel 112 may include one or more electrical and/or magnetic connections to couple to the display screen 110 and/or the keyboard sections 106, 108. In some examples, the outer sides of the keyboard sections 106, 108 (for example, the left-hand side of the first keyboard section 106 and the right-hand side of the second keyboard section 108) may include one or more magnets to physically couple the keyboard sections 106, 108 to the control panel 112, and may include one or more electrical connections (for example, similar to the electrical connections 518, 520) to form an electrical connection with the keyboard sections 106, 108. The control panel 112 may alternatively or additionally be magnetically and/or electrically coupled to either of the electrical connections 518, 520. The control panel 112 may include similar electrical connections on either side.

Accordingly, in some examples, the control panel 112 may be electrically and physically coupled to the first keyboard section 106 on one side, and to the display 110 on an opposite side (and the display 110, in turn, may be coupled to the control panel 112 on one side and to the second keyboard section 108 on an opposite side); or to the display 110 on one side, and to the second keyboard section 108 on an opposite side (and the display 110, in turn, may be coupled to the control panel 112 on one side and to the first keyboard section 106 on an opposite side); or to the first keyboard section 106 on one side, and to the second keyboard section 108 on an opposite side; or to any of the keyboard sections 106, 108 or the display 110 on one side, and to nothing on an opposite side.

In some examples, two or more components of the modular accessory 102 may be physically coupled together via a magnetic connection as discussed above. In other examples, components of the modular accessory 102 may be coupled together via one or more alternative means, such as via jacks, plugs, snap-in connectors, or other types of physical connectors which may or may not be integrated with electrical connectors.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A modular computer peripheral including:
a display configured to be communicatively coupled to a computing device, the display including a first electrical connection and a second electrical connection; and
a keyboard including a first keyboard section and a second keyboard section each configured to be communicatively coupled to the computing device, wherein
the first keyboard section is configured to be electrically coupled to the first electrical connection to receive first charging power, and
the second keyboard section is configured to be electrically coupled to the second electrical connection to receive second charging power.

2. The modular computer peripheral of claim 1, wherein the first keyboard section is configured to be removably physically coupled to the second keyboard section.

3. The modular computer peripheral of claim 2, wherein the first keyboard section is configured to be removably physically coupled to the second keyboard section via a magnetic connection.

4. The modular computer peripheral of claim 2, wherein the first keyboard section is configured to be removably physically coupled to a first side of the display.

5. The modular computer peripheral of claim 4, wherein the second keyboard section is configured to be removably physically coupled to a second side of the display.

6. The modular computer peripheral of claim 5, wherein the first side is opposite the second side.

7. The modular computer peripheral of claim 1, further comprising a first tilting component removably coupled to the first keyboard section and a second tilting component removably coupled to the second keyboard section.

8. The modular computer peripheral of claim 7, wherein the first tilting component is configured to be removably physically coupled to a bottom surface of the first keyboard section and the second tilting component is configured to be removably physically coupled to a bottom surface of the second keyboard section.

9. The modular computer peripheral of claim 8, wherein the first tilting component is configured to be removably physically coupled to the bottom surface of the first keyboard section such that the first tilting component tilts the first keyboard section off of a surface on which the first keyboard section is placed, and wherein the second tilting component is configured to be removably physically coupled to the bottom surface of the second keyboard section such that the second tilting component tilts the second keyboard section off of the surface on which the second keyboard section is placed.

10. The modular computer peripheral of claim 9, wherein the first tilting component is configured to be removably physically coupled to a back section of the bottom surface of the first keyboard section, and wherein the second tilting component is configured to be removably physically coupled to a back section of the bottom surface of the second keyboard section.

11. The modular computer peripheral of claim 9, wherein the first tilting component is configured to be removably physically coupled to a front section of the bottom surface of the first keyboard section, and wherein the second tilting component is configured to be removably physically coupled to a front section of the bottom surface of the second keyboard section.

12. The modular computer peripheral of claim 9, wherein the first tilting component is configured to be removably physically coupled to an inner-edge section of the bottom surface of the first keyboard section, and wherein the second tilting component is configured to be removably physically coupled to an inner-edge section of the bottom surface of the second keyboard section.

13. The modular computer peripheral of claim 9, wherein the first tilting component is configured to be removably physically coupled to an outer-edge section of the bottom surface of the first keyboard section, and wherein the second tilting component is configured to be removably physically coupled to an outer-edge section of the bottom surface of the second keyboard section.

14. The modular computer peripheral of claim 1, wherein the display is configured to receive input charging power from the computing device and to:
provide, to the first keyboard section via the first electrical connection, the first charging power derived from the input charging power; and
provide, to the second keyboard section via the second electrical connection, the second charging power derived from the input charging power.

15. The modular computer peripheral of claim 1, wherein the display includes a display screen and a base section.

16. The modular computer peripheral of claim 15, wherein the base section includes one or more sliding tracks.

17. The modular computer peripheral of claim 16, wherein the display includes at least one sliding coupler configured to be slidably coupled to the one or more sliding tracks.

18. The modular computer peripheral of claim 17, wherein the display includes an orientation arm rotatably coupled to the display screen at a first end and to the base section at a second end.

19. The modular computer peripheral of claim 18, wherein sliding the display screen along the one or more sliding tracks rotates the display screen about the orientation arm.

20. The modular computer peripheral of claim 1, wherein the display includes a first magnetic connection to physically connect a first side of the display to the first keyboard section, and includes a second magnetic connection to physically connect a second side of the display to the second keyboard section, wherein the first side of the display is opposite the second side of the display.
